(19) United States
(12) Patent Application Publication
(10) Pub. No.: US 2016/0205557 A1
(43) Pub. Date: Jul. 14, 2016

(54) CONTROLLING NETWORK ACCESS

(71) Applicant: NOTAVA OY, Espoo (FI)

(72) Inventors: Juha-Matti TUUPOLA, TAMPERE (FI); Risto SUORANTA, TAMPERE (FI); Timo ERIKSSON, ESPOO (FI); Mikko HURSKAINEN, HELSINKI (FI); Teemu HIRSIKANGAS, TAMPERE (FI); Kari KAILAMAKI, ESPOO (FI)

(21) Appl. No.: 15/023,431

(22) PCT Filed: Sep. 19, 2014
(86) PCT No.: PCT/FI2014/050720

§ 371 Date: Mar. 21, 2016

Related U.S. Application Data
(60) Provisional application No. 61/880,236, filed on Sep. 20, 2013.

(51) Int. Cl. H04W 12/08

(52) U.S. Cl. CPC H04W 12/08

(57) ABSTRACT

A technique for managing access to one or more wireless networks in a policy proxy server includes receiving, from a network policy server, a network access policy for a mobile communication device, the network access policy defining one or more rules for determining wireless networks that are currently recommended for the device executing, in response to receiving a trigger signal, the network access policy to select one or more recommended wireless networks for the device, the trigger signal including an authorization request from an authorization server, the request requesting access to a specific wireless network for the device, and enforcing the network access policy by providing, to a remote entity, in response to the specific wireless network being one of the wireless networks currently recommended for device, an authorization indication that indicates that the device is authorized to access the specific network, wherein the remote entity includes an authorization server.

### TECHNICAL FIELD

The example and non-limiting embodiments of the present invention relate to a technique for managing network access for a mobile communication device.

### BACKGROUND

3GPP ANDSF specification enables mobile operators to utilize WLAN and other non-3GPP radio access networks as part of their wireless capacity in an end-user friendly way. The system consists of an ANDSF server and clients exchanging information in-between to ease discovering valid WLAN networks.

Currently there are no devices on the market with native ANDSF support. Some companies have implemented ANDSF client applications that implement a subset of the ANDSF features. These are typically limited to certain platform types and versions and in the extreme case require a “rooted” device. The first ANDSF servers are seeing the daylight while the device side is support-wise lacking far behind.

### SUMMARY OF THE INVENTION

According to an example embodiment, a method for managing access to one or more wireless networks in a policy proxy server is provided. The method comprises receiving, from a network policy server, a network access policy for a mobile communication device, the network access policy defining one or more rules for determining wireless networks that are currently recommended for said mobile communication device, executing, in response to receiving a trigger signal, said network access policy to select one or more recommended wireless networks for said mobile communication device, wherein said trigger signal comprises an authorization request from an authorization server, said authorization request requesting access to a specific wireless network for said mobile communication device, and enforcing said network access policy by providing, to a remote entity, in response to said specific wireless network being one of the wireless networks currently recommended for said mobile communication device, an authorization indication that indicates that said mobile communication device is authorized to access said specific network, wherein said remote entity comprises an authorization server.

According to another example embodiment, a computer program for managing access to one or more wireless networks in a policy proxy server is provided. The computer program includes one or more sequences of one or more instructions which, when executed by one or more processors, cause an apparatus to at least receive, from a network policy server, a network access policy for a mobile communication device, the network access policy defining one or more rules for determining wireless networks that are currently recommended for said mobile communication device, execute, in response to receiving a trigger signal, said network access policy to select one or more recommended wireless networks for said mobile communication device, wherein said trigger signal comprises an authorization request from an authorization server, said authorization request requesting access to a specific wireless network for said mobile communication device, and enforce said network access policy by providing, to a remote entity, in response to said specific wireless network being one of the wireless networks currently recommended for said mobile communication device, an authorization indication that indicates that said mobile communication device is authorized to access said specific network, wherein said remote entity comprises an authorization server.

According to another example embodiment, a policy proxy server apparatus for managing access to one or more wireless networks is provided. The policy proxy server apparatus comprises at least one processor and at least one memory including computer program code for one or more programs, the at least one memory and the computer program code configured to, with the at least one processor, cause the apparatus to perform at least the following: receive, from a network policy server, a network access policy for a mobile communication device, the network access policy defining one or more rules for determining wireless networks that are currently recommended for said mobile communication device, execute, in response to receiving a trigger signal, said network access policy to select one or more recommended wireless networks for said mobile communication device, wherein said trigger signal comprises an authorization request from an authorization server, said authorization request requesting access to a specific wireless network for said mobile communication device, and enforce said network access policy by providing, to a remote entity, in response to said specific wireless network being one of the wireless networks currently recommended for said mobile communication device, an authorization indication that indicates that said mobile communication device is authorized to access said specific network, wherein said remote entity comprises an authorization server.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### SUMMARY OF SOME ABBREVIATIONS USED IN THIS TEXT

3GPP Third generation Partnership Program
AAA Authentication, Authorization and Accounting
ANDSF Access Network Discovery and Selection Function
ANDSF-PS ANDSF Proxy Server, software running ANDSF proxy functions
HLR Home Location Registry
IP Internet Protocol
ISMP Inter-system mobility policy
ISRP Inter-system routing policy
MAP Mobile Application Part
MO Management Object
NMS Network Management System
OCS Online Charging System
OFCS Offline Charging System
PCEF Policy and Charging Enforcement Function
RADIUS Remote Authentication Dial In User Service
S14 ANDSF reference point or any vendor specific ANDSF interface
SCTP Stream Control Transmission Protocol
SIGTRAN SS7 SCTP Signaling Transport
SMPP Short Message Peer to Peer
SNMP Simple Network Management Protocol
SMSC Short Message Service Center
SS7 Signaling System 7
UE User Equipment
WLAN IEEE 802.11 Wireless LAN

### BRIEF DESCRIPTION OF THE DRAWINGS

The embodiments of the invention are illustrated by way of example, and not by way of limitation, in the figures of the accompanying drawings.

FIG. 1 schematically illustrates system components according to an example embodiment.

FIG. 2 schematically illustrates ANDSF server and ANDSF-PS integration according to an example embodiment.

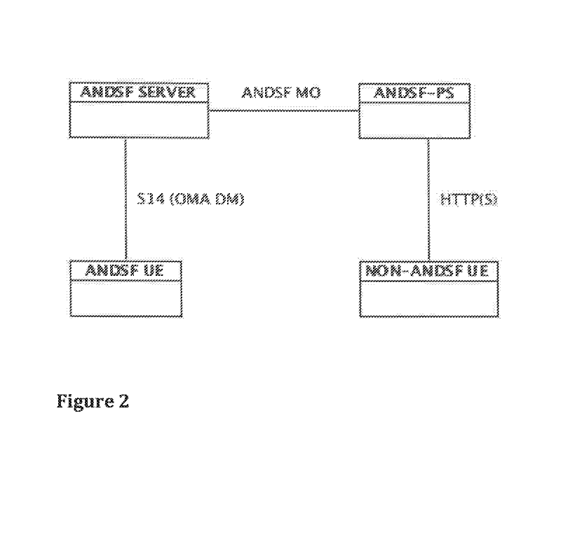

FIG. 3 illustrates signaling related to ANDSF server and native ANDSF UE provisioning according to an example embodiment.

FIG. 4 illustrates signaling related to ANDSF/ANDSF-PS based policy enforcement for LCMP devices according to an example embodiment.

FIG. 5 illustrates signaling related to ANDSF/ANDSF-PS based policy enforcement for HCMP devices according to an example embodiment.

FIG. 6 schematically illustrates ANDSF/ANDSF-PS related entities and interfaces according to an example embodiment.

FIG. 7 schematically illustrates ANDSF MO and identities according to an example embodiment.

FIG. 8 illustrates signaling related to LCMP device provisioning according to an example embodiment.

FIG. 9 illustrates signaling related to dynamic LCMP device provisioning while roaming according to an example embodiment.

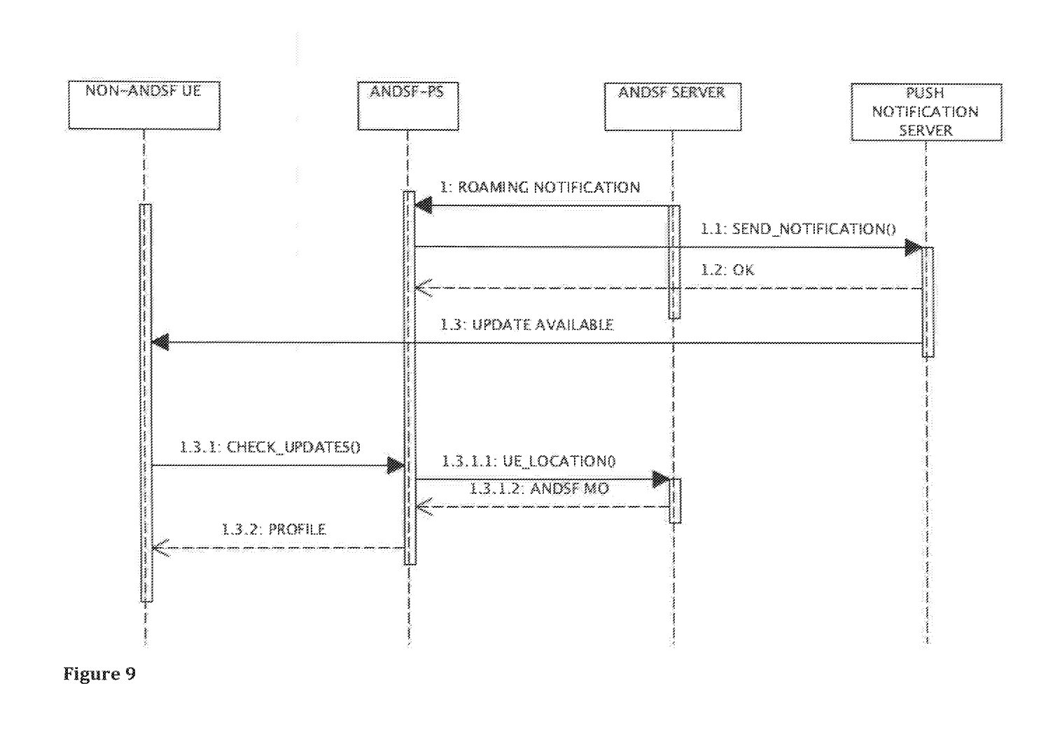

FIG. 10 illustrates signaling related to LCMP device location and time-based WLAN access enforcement according to an example embodiment.

FIG. 11 illustrates signaling related to WLAN network prioritization of a LCMP device according to an example embodiment.

FIG. 12 illustrates signaling related to client software provisioning to HCMP devices according to an example embodiment.

FIG. 13 illustrates signaling related to ANDSF-based WLAN access enforcement for HCMP devices according to an example embodiment.

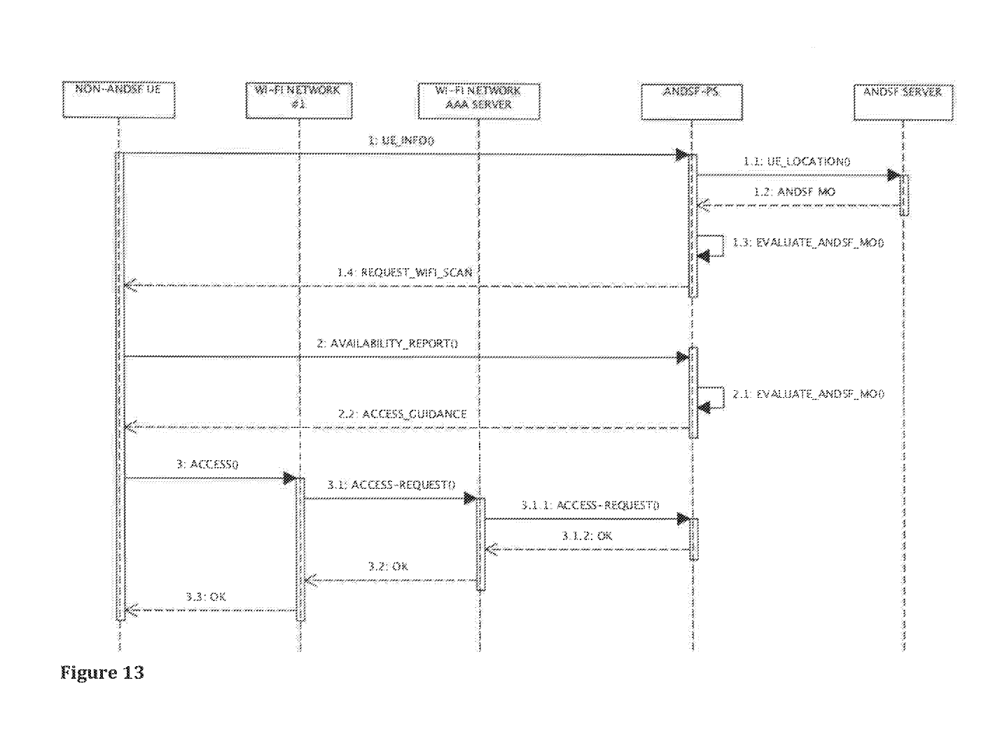

FIG. 14 schematically illustrates WLAN enforcement with an external enforcement unit in data path according to an example embodiment.

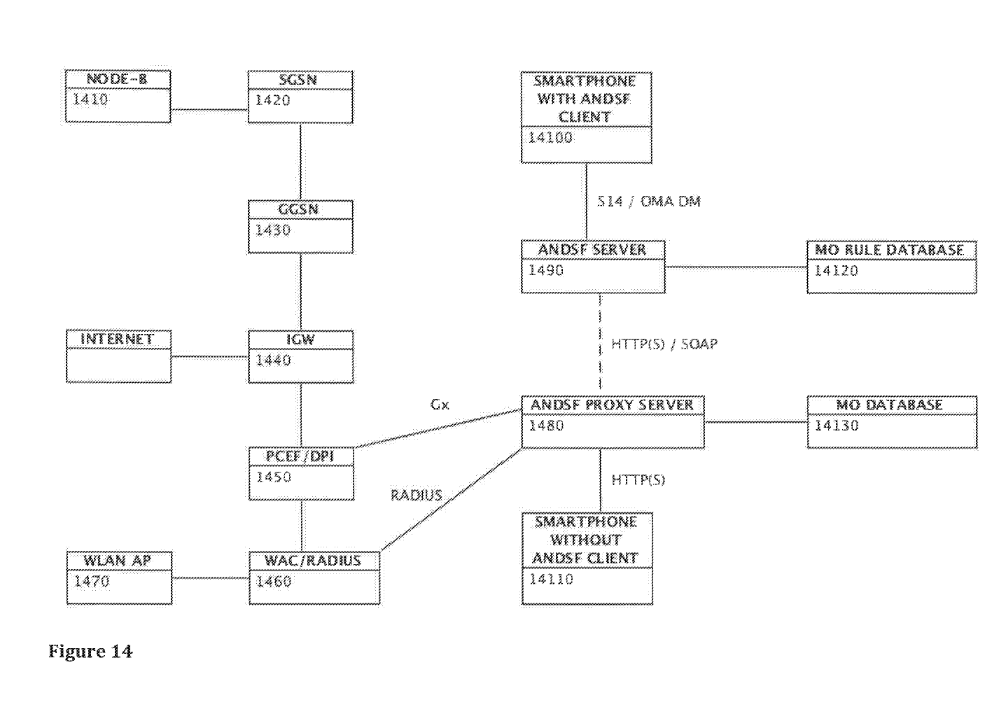

### DESCRIPTION OF SOME EMBODIMENTS

In the following, a technique for managing access to one or more wireless networks by employing a dedicated policy proxy server is described. A benefit of such technique is that it enables a mobile communication device that is not itself capable of policy-based network access management to make use of this approach such that the policy proxy server takes care of network access policy execution and (at least part of the) network access policy execution on behalf of the mobile communication device. Policy-based network access management approach enables efficient use of wireless network resources as a whole as well as improved wireless network connectivity for a given mobile communication device—and employing the policy proxy server in accordance with the technique described herein facilitates providing these benefits also to mobile communication devices that are not provided with a capability to apply policy-based network access management on their own.

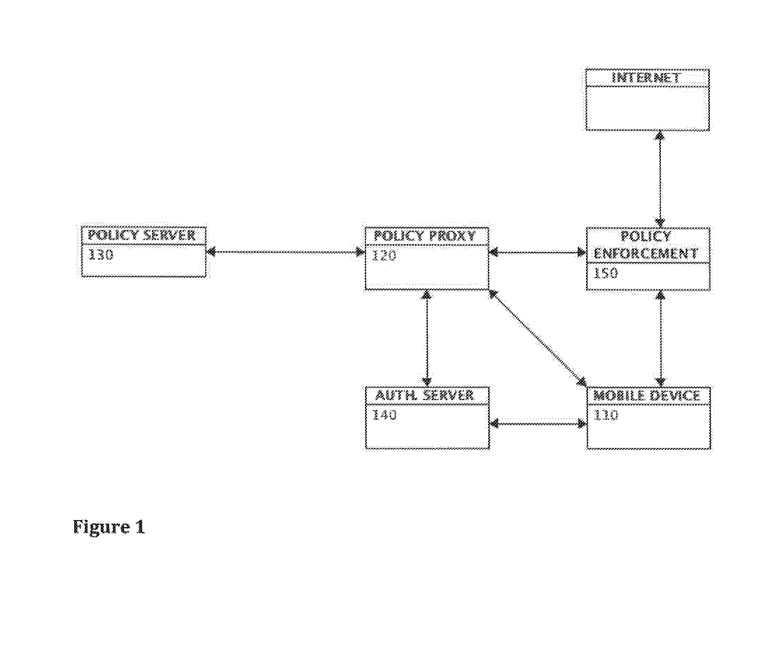

FIG. 1 schematically depicts some components of an arrangement or a system within which the described technique may be employed. The arrangement/system comprises a mobile communication device 110 for providing access to one or more wireless networks, a policy proxy server 120 for managing the access to the wireless networks by executing and (at least partially) enforcing a network access policy, and a network policy server 130 for storing, managing and providing network access policies. FIG. 1 further depicts an authorization server 140 and a policy enforcement entity 150, either or both provided for controlling the mobile communication device 110 accessing the wireless networks.

The technique for managing access to the wireless networks is first described as a method to be carried out in the policy proxy server 120.

The method comprises the policy proxy server 120 receiving, from the network policy server 130, a network access policy designated for the mobile communication device 110. The network access policy defines one or more rules for determining wireless networks that are currently recommended for said mobile communication device 110. The wireless networks under consideration herein may include one or more wireless cellular networks and/or one or more wireless local area networks.

A network access policy designated for the mobile communication device 110 may be selected, for example, on basis of identity of the mobile communication device 110 and/or the (current) location of the mobile communication device 110. Consequently, the policy proxy server 120 may obtain the network access policy for the mobile communication device 110 by sending a request to the network policy server 130, the request comprising particulars of the mobile communication device 110, e.g. the identity and/or location of the mobile communication device 110. As a response, the network policy server 130 may select from a predetermined set of network access policies the particulars of the mobile communication device 110 and provide the network access policy or an indication thereof to the policy proxy server 120.

The network policy server 130 may be for example a server entity providing an Access Network Discovery and Selection Function (ANDSF), i.e. an ANDSF server, defined e.g. in [3].

Selection rule(s) defined by a network access policy may be arranged to determine wireless networks that are currently recommended for the mobile communication device 110 at least in part on basis of the (current) location the mobile communication device. The selection rule(s) may further consider e.g. the time of the day and/or the day of the week in defining the recommended wireless networks. The selection may be made from a predetermined list of wireless networks, which list may be a static list or a list that is dynamically updated. The selection rule(s) may consider the availability statuses of the wireless networks in the list and/or a priority order defined for the wireless networks in the list. The availability status may be applied to indicate one or more wireless networks in the list to be (currently) available or unavailable.

The network access policy may be provided in any suitable format, e.g. as an xml item. In particular, in case the network policy server 130 is provided as an ANDSF server, the network access policy is preferably provided as an ANDSF Management Object (MO), defined e.g. in [1].

The policy proxy server 120 may update the network access policy designated for the mobile communication device 110 in response to receiving an update to respective network access policy from the network policy server 130. The network policy server 130, in turn, may update or refresh the respective network access policy e.g. in accordance with a predefined schedule and/or in response to indication(s) of the change in the load or status of one or more wireless networks. As an example, the network policy server 130 may push the updated network access policy to the policy proxy server 120.

The policy proxy server 120 may request an update to the network access policy designated for the mobile communication device 110 from the network policy server 130. The request may be triggered for example by one or more of the following conditions: expiration of a validity period defined for the network access policy, encountering a predefined time of the day and/or a predetermined day of the week, receiving an indication of the mobile communication device 110 entering or exiting one of one or more predefined locations, receiving an indication of connectivity status of the mobile communication device with respect to a cellular wireless network changing to one of predetermined statuses, receiving an indication of connectivity status of the mobile communication device with respect to a wireless local area network changing to one of predetermined statuses. Herein, the network status may refer e.g. to the mobile communication device 110 being connected to or disconnected from the respective wireless network and/or to a quality estimate descriptive of the quality of the connection between the mobile communication device 110 and the respective wireless network.

The method further comprises the policy proxy server 120 executing, in response to a trigger signal, the network access policy designated for the mobile communication device 110 in order to select one or more recommended wireless networks for said mobile communication device 110.

The method further comprise enforcing the network access policy designated for the mobile communication device 110 by providing, to at least one remote entity and/or to at least one local entity, an authorization indication regarding at least one of the recommended wireless networks.

The trigger signal may comprise, for example, an authorization request originating from the authorization server 140. In this regard, the authorization server 140 may provide the authorization request to the policy proxy server 120 in response to the mobile communication device 110 attempting to a wireless networks under control of the authorization server 140. The authorization request may comprise a request for the mobile communication device 110 to access a specific wireless network and/or an indication of the mobile communication device 110 attempting to access the specific wireless network. Consequently, the enforcement action by the policy proxy server 120 may comprise providing, to the authorization server 140, an authorization indication that indicates that the mobile communication device 110 is authorized to access said specific network in response to said specific wireless network being one of the wireless networks currently recommended for the mobile communication device 110 on basis of the currently applicable network access policy. In contrast, in case the specific wireless network is not one of the recommended networks, the policy proxy server 120 may provide the authorization server 140 with an indication that indicates that the mobile communication device 110 is not authorized to access said specific wireless network. As an alternative to responding with the authorization status of the specific wireless network referred to in the authorization request, the policy proxy server 120 may respond to the authorization server 140 with an authorization indication that indicates that said mobile communication device is authorized to access (all) the wireless networks currently recommended for said mobile communication device 110. Additionally, such authorization indication (or a separate indication) may be used to indicate to the authorization server 140 the wireless networks considered under the applicable network access policy that are not in the group of recommended wireless networks as wireless networks the mobile communication device 110 is (currently) not authorized to access. The authorization server 140 may then employ the information received in the authorization indication to update its internal records with respect to wireless network(s) the mobile communication device 110 is currently allowed (and/or not allowed) to access.

The authorization server may be provided e.g. as an authentication, authorization and accounting (AAA) server, such as a RADIUS server [4] or a Diameter server [5].

As another example, the trigger signal may comprise a status update signal from said mobile communication device 110. The status update signal may comprise e.g. an indication of identity of the mobile communication device 110 and/or indication of (the current) location of the mobile communication device 110. Consequently, the enforcement action by the policy proxy server 120 may comprise providing, to the mobile communication device 110, an authorization indication that indicates that the mobile communication device 110 is authorized to access (all) the wireless networks currently recommended for the mobile communication device 110 on basis of the applicable network access policy. Additionally, the policy proxy server 130 may further provide the mobile device 110 with access credentials to the recommended wireless networks.

Instead of or in addition to providing the authorization indication to the mobile communication device 110, the enforcement action may comprise providing the authorization indication to the authorization server 140 and/or to the policy enforcement server 150. On the other hand, instead of receiving the trigger signal from the mobile communication device 110, the trigger signal may originate from the policy enforcement server 150 or from an entity of a core network of a wireless cellular network the mobile communication device 110 is utilizing. An example of such core network element is a Policy Charging and Rules Function (PCRF), as defined e.g. in [6] For both the policy enforcement server 150 and the core network element the authorization process may follow the outline described hereinbefore for the authorization server 140, i.e. the trigger signal may comprise the authorization request and the response thereto may comprise the authorization indication, while the respective server/element may update its internal records with respect to wireless network(s) the mobile communication device 110 is currently allowed (and/or not allowed) to access accordingly.

The policy enforcement server 150 may be provided e.g. as a Policy and Charging Enforcement Function (PCEF) entity, as defined e.g. in [6].

The method may further comprise the policy proxy server 120 providing one or more predetermined wireless network access profiles to the mobile communication device 110 in response to a predetermined condition. Such condition may be, for example, the policy proxy server 120 receiving a registration request for the mobile communication device (e.g. from the mobile communication device 110 itself) or a change/update in the network access policy designated for the mobile communication device 110.

In the numbered sections provided later in this text, some embodiments of the technique described in the foregoing in framework of the arrangement/system of FIG. 1 are described in more detail. In the description provided in the numbered sections, among other things, the mobile communication device 110 is represented by the non-ANDSF User Equipment (UE), the policy proxy server 120 is represented by the ANDSF proxy server (ANDSF-PS), the network policy server 130 is represented by the ANDSF server, the authorization server 140 is presented by the Wi-FI AAA server and the policy enforcement entity 150 is represented by the PCEF.

The operations, procedures, functions and/or methods described for each of the mobile communication device 110, the policy proxy server 120, the network policy server 130 and the authentication server 140 may be provided as software means, as hardware means, or as a combination of software means and hardware means.

As an example, the operations, procedures, functions and/or method steps described hereinbefore for each of the mobile communication device 110, the policy proxy server 120, the network policy server 130 and the authentication server 140 may be provided, at least in part, as a respective computer program, the computer program including one or more sequences of one or more instructions which, when executed by one or more processors, cause an apparatus to at least perform the operations, procedures, functions and/or method steps described for the respective entity.

As another example, each of the mobile communication device 110, the policy proxy server 120, the network policy server 130 and the authentication server 140 may be provided as an apparatus comprising at least one processor and at least one memory including computer program code for one or more programs, the at least one memory and the computer program code configured to, with the at least one processor, cause the apparatus to perform the operations, procedures, functions and/or method steps described hereinbefore in context of the corresponding entity.

The following numbered sections describe various aspects related to some embodiments of the invention.

### 1 Architecture

Access to the network is controlled with an ANDSF Management Object (MO) comprising instructions for the UE which access network to use and when. With ANDSF UE, the MO is in the UE and the UE uses it to configure the UE accordingly. If the ANDSF server changes the MO, the UE changes its operation accordingly. With the ANDSF-PS the MO is on the ANDSF-PS and it controls the UE with ANDSF-PS proprietary protocol.

When ANDSF server is used together with the ANDSF-PS, ANDSF-PS operates as an ANDSF UE towards the ANDSF server. Part of the ANDSF UE functionality runs in the ANDSF-PS and part of it runs in the mobile client software. Together they enable the ANDSF server to control the UE as if it was a native ANDSF UE.

ANDSF Proxy Server (ANDSF-PS) implements the bi-directional ANDSF client interface comprising the intelligence to perform the typical client requests towards the server and enforce the client WLAN network selection based on the policy from the server.

This Chapter defines the ANDSF and ANDSF-PS related logical entities with interfaces. MSC based use-cases are used to open up the communication between the entities.

### 1.1 Generic Use-Cases

ANDSF server and UE communication is bi-directional. This Chapter describes the generic use-cases for both the native ANDSF UE and ANDSF-PS based approaches. Specific use-cases are described with more detail in Chapter 2.

### 1.1.1 ANDSF Server and Native ANDSF UE

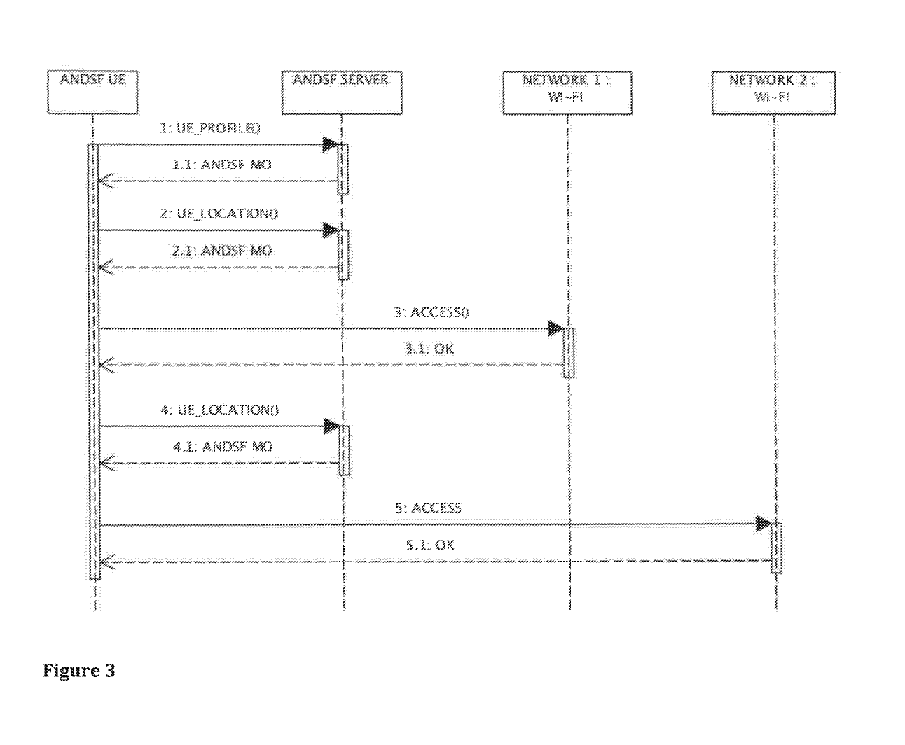

ANDSF server and ANDSF UE communicate using OMA-DM exchanging ANDSF MOs with each other. UE provides information about its capabilities and location towards the server. ANDSF replies back with an ANDSF policy instructing the UE to use the non-3GPP networks. The message exchange of this use case is depicted in FIG. 3

### 1.1.2 ANDSF Server, ANDSF-PS and Non-ANDSF UE

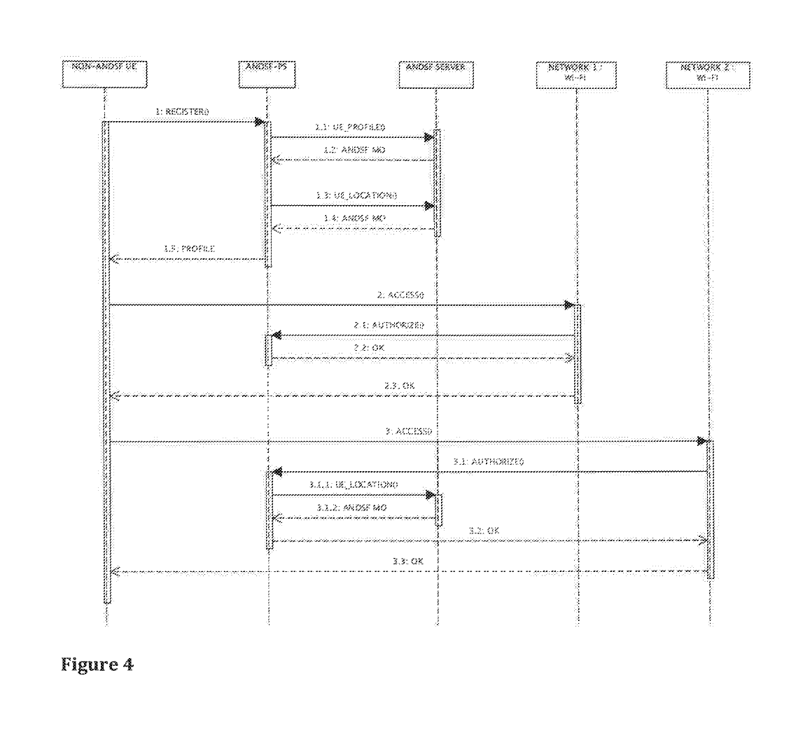

The FIG. 4 illustrates the operation of the ANDSF server with the ANDSF-PS using a less configurable mobile platform (LCMP) such as iOS device. User registration with the ANDSF-PS initiates the communication with the ANDSF server. As part of the registration, ANDSF-PS provides information about the UE to the ANDSF server and receives the ANDSF MO. Followed by this; ANDSF-PS pushes a WLAN profile to the LCMP device and configures the server side policy to act according to the ANDSF MO. ANDSF-PS supports having a unique individual policy per UE.

ANDSF-PS comprises the intelligence to request ANDSF MO updates from the ANDSF server based on the device state changes. How often and by which trigger the new request is done towards the ANDSF server is a configuration parameter inside the ANDSF-PS. E.g. UE location change on WLAN location can lead to a new ANDSF MO request towards the ANDSF server.

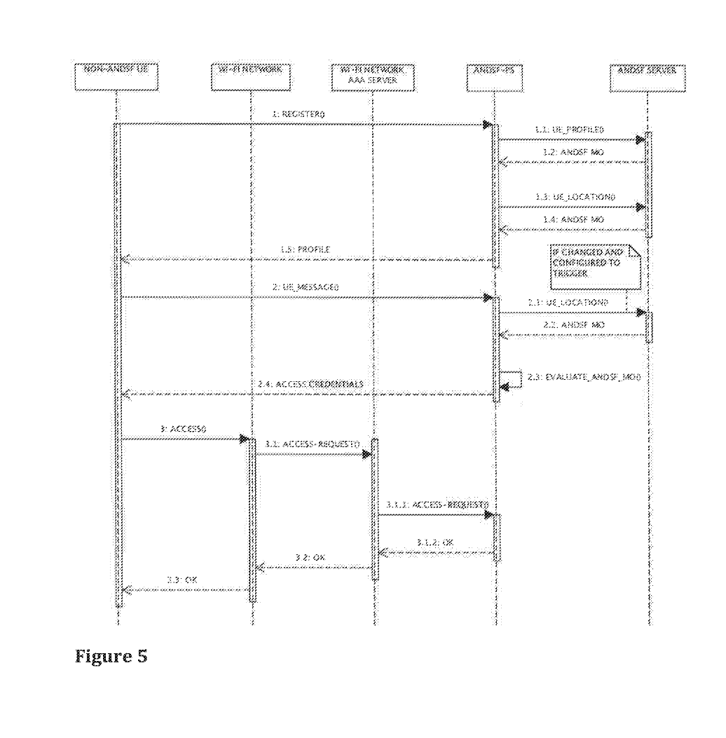

The registration and the Wi-Fi access are slightly different with highly configurable mobile platforms (HCMP) such as Android. From ANDSF server—ANDSF-PS communication point of view the operation is, however, the same. ANDSF-PS application in HCMP devices runs on background and uses temporary access credentials created by the server. The process is seamless to the end-user. The process is presented in FIG. 5.

With both HCMP and LCMP UE the ANDSF-PS manages the access to the network according to the ANDSF MO. In LCMP case the access control is based on the deployed WLAN profiles together with gating the radius access request on the network side. Identity can be based on a client certificate (created during registration) or SIM. In HCMP device, the process is handled by the background application running in the UE. Here the application dynamically manages the location profiles (with temporal credentials) based on server decision.

### 1.2 Entities

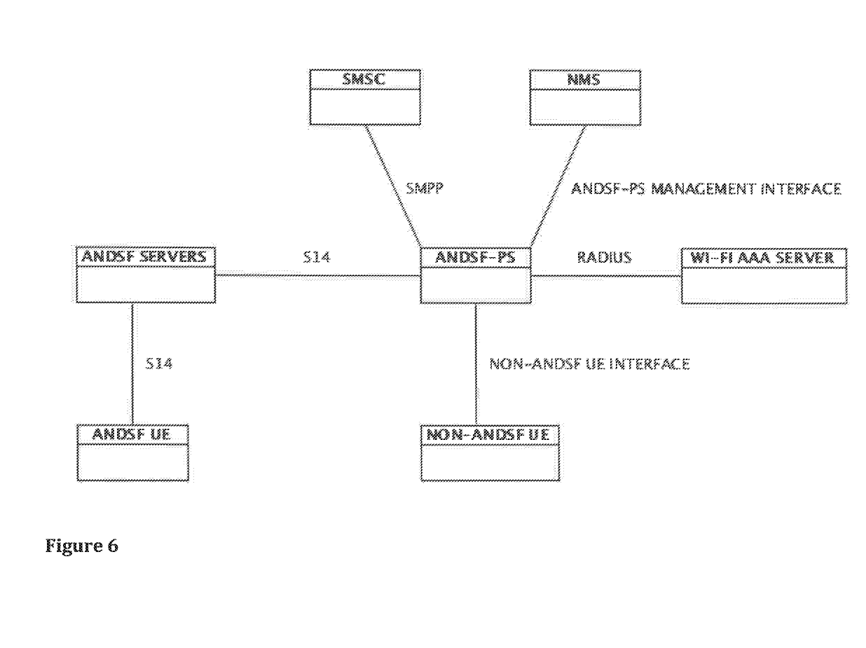

The entities listed in FIG. 6 are described in this chapter with their functionalities.

### 1.2.1 ANDSF Proxy Server

ANDSF-PS entity is responsible for individual UE policy enforcement based on the ANDSF MO obtained from the ANDSF server. ANDSF-PS also implements the intelligence related to the ANDSF MO update requests (e.g. triggered by UE location change) towards the ANDSF server.

In case of EAP-SIM type devices, ANDSF-PS forwards the access request to the master AAA or directly to the HLR (MAP/SIGTRAN). With dynamic credentials and EAP-TLS, it is a configuration issue whether the user authentication is done at every access time. In this case it is enough to check whether the user exists and can be done via the master AAA, HLR, OCS or ANDSF server.

### 1.2.2 ANDSF Server

ANDSF server is responsible for managing individual UEs access to WLAN networks through policies (ANDSF MOs). Server may issue new policies triggered by information coming from the UEs and/or core network. In the ANDSF-PS context, ANDSF-PS possesses the intelligence to send UE related context changes to the ANDSF server to possibly initiate an ANDSF MO update.

### 1.2.3 ANDSF UE

The ANDSF UE is a UE that natively supports the ANDSF MO and can control its own access according to the ANDSF MO.

### 1.2.4 Non-ANDSF UE

The non-ANDSF UE is a UE that does not natively support the ANDSF MO. With non-ANDSF UEs, ANDSF-PS controls the access to the network according to the ANDSF MO.

### 1.2.5 WLAN AAA Server

Master WLAN AAA server provides the access control for the WLAN network. ANDSF-PS forwards the access requests to the master AAA after checking the UE related ANDSF policy. The above operations are done for the realms forwarded from the WLAN networks towards the ANDSF-PS (through the master AAA or directly from the WLAN network controllers).

For non EAP-SIM devices, ANDSF-PS performs the MSISDN resolution. This information is used to authenticate the access and to charge the user. How this is done depends on the operator's network configuration. Both PCEF and non-PCEF based approaches are supported.

### 1.2.6 SMSC

SMSC is used for initial user authentication during registration for SIM based devices (network terminated SMS). As a result of a successful registration, LCMP devices are pushed new WLAN profiles with individual TLS certificates. With all devices, a unique ANDSF-PS identity (UUID) is created for the successfully registered devices and bind to the MSISDN/IMSI. SMSC can also be used to trigger individual device offloading process. Validity of this option depends on the platform type (e.g. supported in Android).

### 1.2.7 NMS

The Network Management System is responsible for storing and presenting network management data. It receives alerts and collects monitoring information of the system in centralized place.

### 1.3 Interfaces

### 1.3.1 ANDSF Server Interface

S14 reference point [1][3] is the basis for interfacing between the ANDSF server and the ANDSF-PS. This interface is used by ANDSF-PS to provide UE related information towards the ANDSF server and as a response, get back the UE related ANDSF policy. From transport protocol point of view, ANDSF-PS acts as a HTTP agent towards the ANDSF server.

### 1.3.2 AAA Server Interface

RADIUS based interface used to receive and forward access and accounting requests, see RADIUS RFCs [2].

### 1.3.3 SMSC Interface

HTTP and SMPP based interface with support for both Mobile Originated (SMS-MO) and Mobile Terminated (SMS-MT) short messages. SMS-MO is used in the registration phase, while SMS-MT is used in offloading triggering.

This interface is needed in case an intelligent client SW is used.

### 1.3.4 ANDSF-PS Management Interface

ANDSF-PS provides HTTP(S)/REST/JSON API and SNMP interfaces to configure the system, trap ALARMs and fetch monitoring and status information.

### 1.4 Subscriber Identities and ANDSF MO

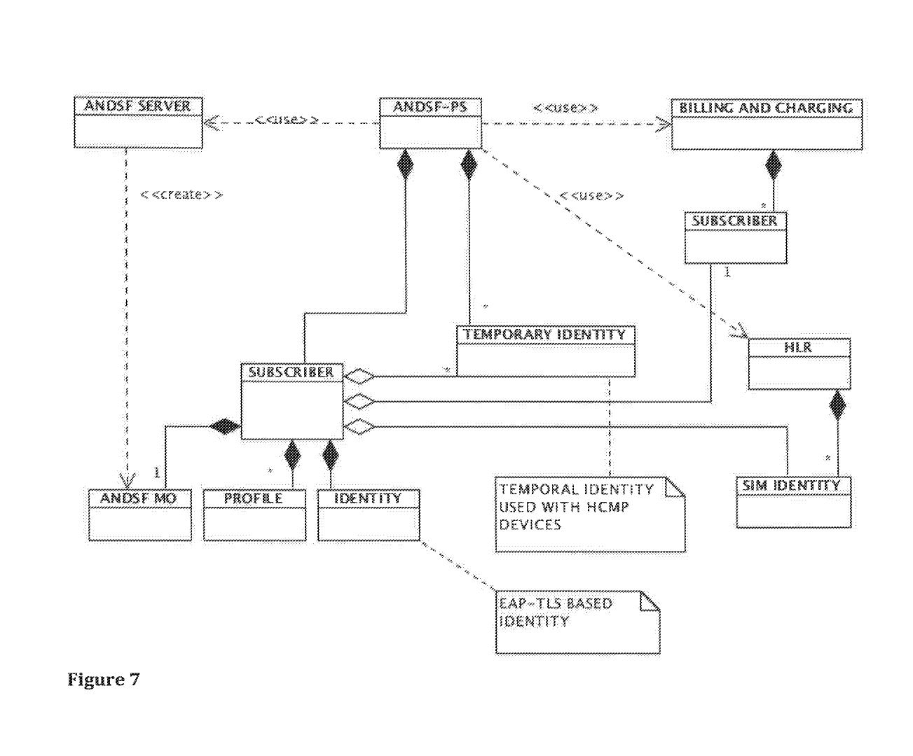

ANDSF-PS uses internally three different kinds of identities (see FIG. 7). Each identity uniquely maps to the subscriber's real identity (MSISDN/IMSI) while the selected one depends on the network configuration and UE platform type.

ANDSF-PS maintains local copy of the ANDSF MO for each subscriber and uses it to evaluate which network/whether network access for UE is allowed or not. The rule defining the frequency when the ANDSF-PS requests a policy update from the ANDSF server can be configured internally. Sensitivity to the UE location change is one typical case where the update frequency can be controlled.

In case of less configurable mobile platforms, such as, iOS either TLS or EAP-SIM based authentication can be used. If TLS approach is used, ANDSF-PS creates a unique TLS identity for the UE, stores it locally and deploys to the device (done during the client SW registration phase). Server configuration defines the frequency related to the MSISDN/IMSI validity is check (e.g. every time the device accesses the network, once per day/week etc.). With EAP-SIM, ANDSF-PS authenticates the UE directly with the HLR or indirectly via the master AAA. HLR load can be relaxed by using the internally supported EAP-SIM fast reconnect feature. It should be noted that in both the TLS and EAP-SIM cases, the authentication takes place ONLY if the ANDSF policy triggers. Network access use-case is presented in Chapter 1.1.2.

HCMP devices use dynamic WLAN profiles with temporal identities to connect to the selected network. ANDSF-PS is responsible for creating the profile and the credentials based on the information from ANDSF MO. Cellular data is used as the control channel to communicate the profile and credentials to the device. The process is presented in FIG. 5.

### 1.4.1 Provisioning

Before the ANDSF based access control can be used, there needs to be means to provision the intelligent client SW and/or the WLAN profiles (with optional TLS certificates) to the devices. ANDSF-PS supports use of both internal or external provisioning approach.

### 1.4.1.1 ANDSF-PS Based Provisioning

ANDSF-PS provides tools for UE provisioning. The list of targeted UEs can be given manually, as a batch file or there can be an external event triggering the provisioning. During provisioning, ANDSF-PS handles both the client SW installation and registrations as well as the WLAN profile creation to the devices.

### 1.4.1.2 Device Management System Based Provisioning

The SW clients and/or profiles can be also provisioned through an existing device management system. ANDSF-PS can handle registration requests coming from devices which have installed the intelligent client SW from 3^{rd} party sources as well as WLAN network access requests from devices utilizing WLAN profiles pushed by 3^{rd} party channels.

### 1.4.2 Subscription Validation

ANDSF-PS can check subscription (MSISDN/IMDI) validity in three different ways:
via HLR using MAP protocol (or HTTP/S in case of HLR lookup service)
via master AAA via RADIUS
via ANDSF server via HTTP (the existence of the ANDSF MO)*
via OCS using WS/SOAP, diameter or RADIUS * If the MO exists and server is providing updates for it, the subscription is assumed valid.
   2 Use cases

This Chapter explains the most common use cases supported by the system. These have been decomposed into the basic system entity level defined in Chapter 2. The two distinct cases are based of different implementation approach depending on the software development and configuration support of a mobile platform. An example of a less configurable mobile platform (LCMP) is Apple iOS and an example of a highly configurable mobile platform (HCMP) is Android.

### 2.1 LCMP Devices

### 2.1.1 Provisioning

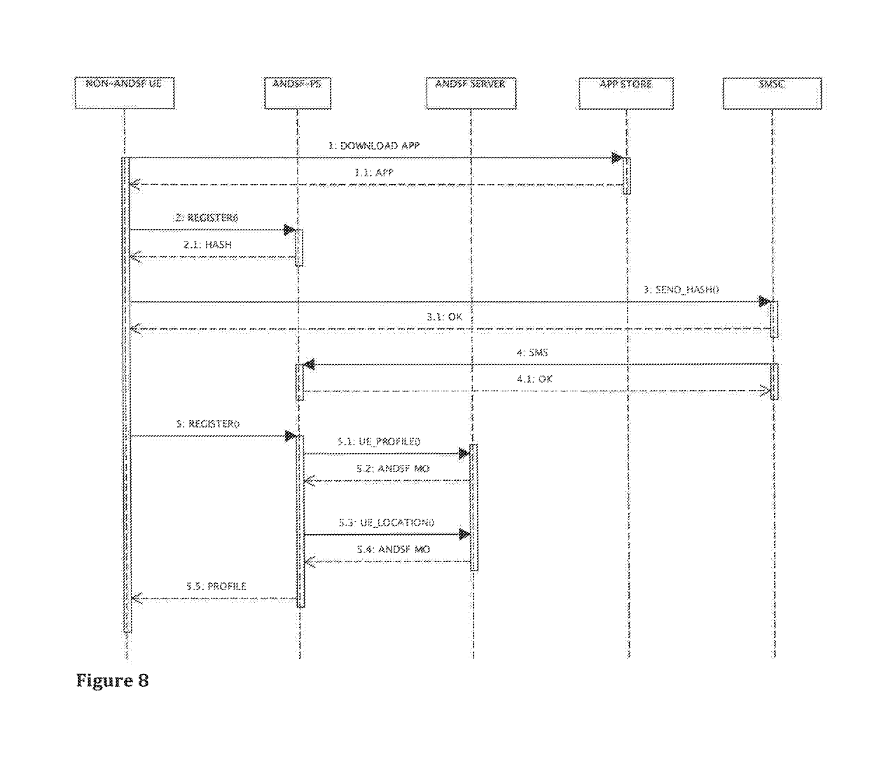

FIG. 8 presents the provisioning of the intelligent client SW to LCMP device. After being installed, the application performs subscriber authentication and downloads/installs the ANDSF server chosen WLAN profiles into the device. If only EAP-SIM profile is needed, application is not necessary needed.

The provisioning with the LCMP device is triggered when the user downloads the client application and begins the registration. The registration includes sending a MO SMS to the ANDSF-PS for authenticating the subscriber. In the provisioning phase the ANDSF server decided Wi-Fi networks together with a UE unique TLS certificate are deployed into the UE. The profiles may naturally also include settings for EAP-SIM networks. The actual access rules (time of day, area, etc.) are not deployed into the device itself but are enforced in the ANDSF-PS.

It is possible that the provisioned device profiles need to be updated—e.g. due to new networks being built or the device is roaming. ANDSF-PS supports updating the profiles dynamically.

### 2.1.2 Dynamic Profile Updates

In case of LCMP ANDSF-PS needs an indication telling a certain device is roaming. This may come from multiple sources including the ANDSF server, HLR, etc. Alternatively the notification could be received from the device by means of end-user action clicking an URL being part of a welcome SMS.

After getting the roaming indication with the roaming location, ANDSF-PS fetches a new access policy from the ANDSF server. Updated network information is pushed to the device by two alternative means. In case the device has the intelligent client SW installed, Apple push message will be used. For devices without the client SW, a plain SMS is used. In both cases, the message comprises a link to the updated profile configuration. This same approach can be applied also to other cases where the device context change triggers provisioning of an updated profile.

An alternative to triggering profile updated based on indications from the core network, ANDSF-PS can be configured to periodically check policy updates from the ANDSF server. In case the ANDSF-PS notices a profile being updated, the provisioning process is automatically started.

### 2.1.3 Time and Location Based Access

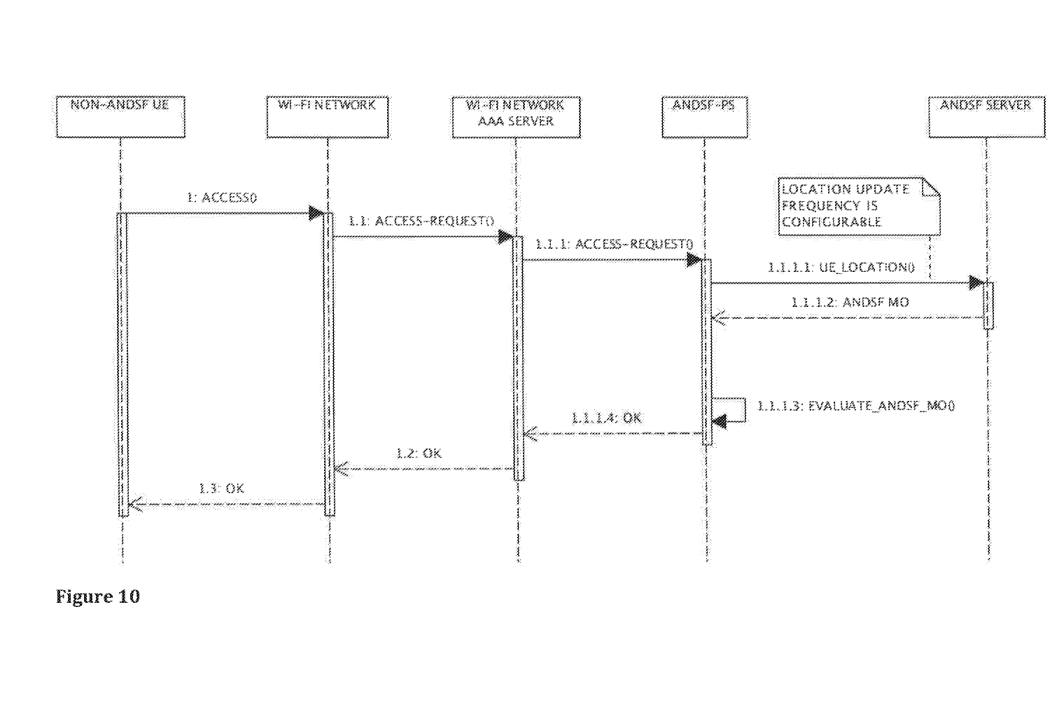

Time and location based WLAN network access enforcement is done on the ANDSF-PS side. The process is presented in FIG. 10. Upon UE accessing to the WLAN network, ANDSF-PS checks the UEs location and current time against the active UE specific ANDSF MO and decides whether the access should be granted or not. The frequency the ANDSF-PS requests a new ANDSF MO due to WLAN access is a configuration parameter (every time, time-to-time, never).

### 2.1.4 WLAN Network Prioritization

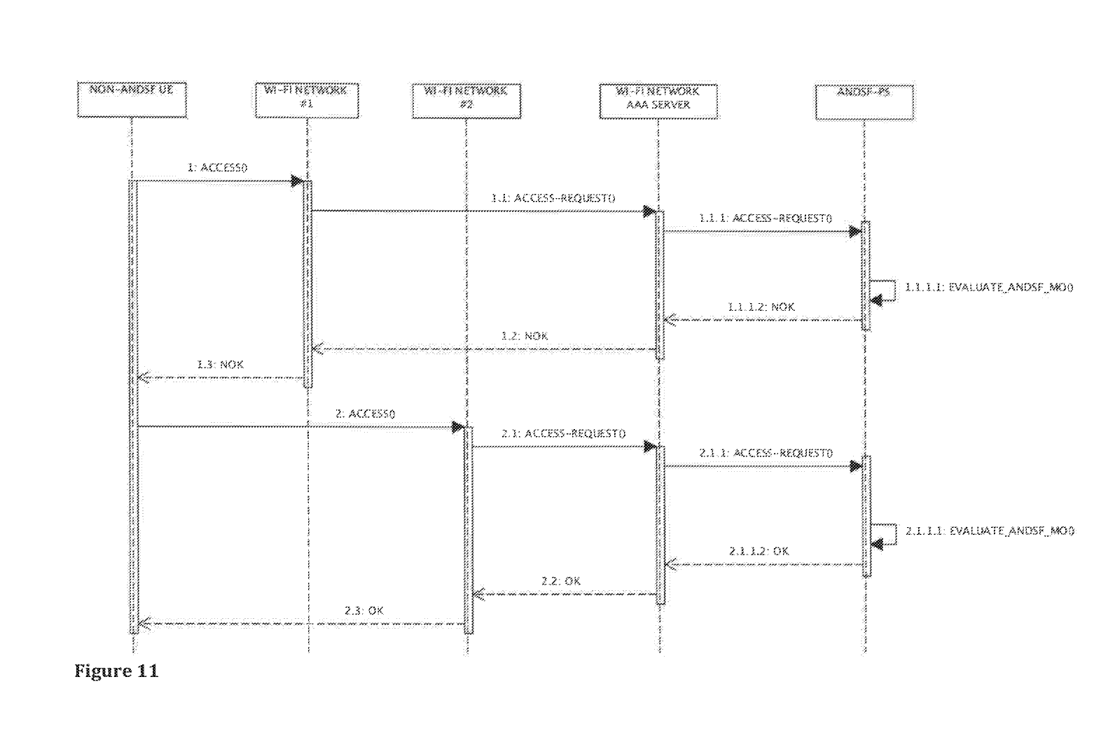

ANDSF-PS supports also network prioritization for the LCMP device. In case the prioritization is between 3GPP and WLAN networks, access to device connectivity status is needed (e.g. from PCRF). In case the prioritization is between different WLAN networks, relative access point location information is needed. For the example, see FIG. 11.

### 2.2 HCMP Devices

ANDSF/ANDSF-PS based WLAN enforcement supports devices without a specific client SW (preconfigured EAP-SIM profile) and devices with installed intelligent client SW. This Chapter focuses in the latter case.

### 2.2.1 Provisioning

Subscribers download and install the client application from the Android Play. Each operator can have an own customized application with tailored look & feel or there can be operators using the same common generic application.

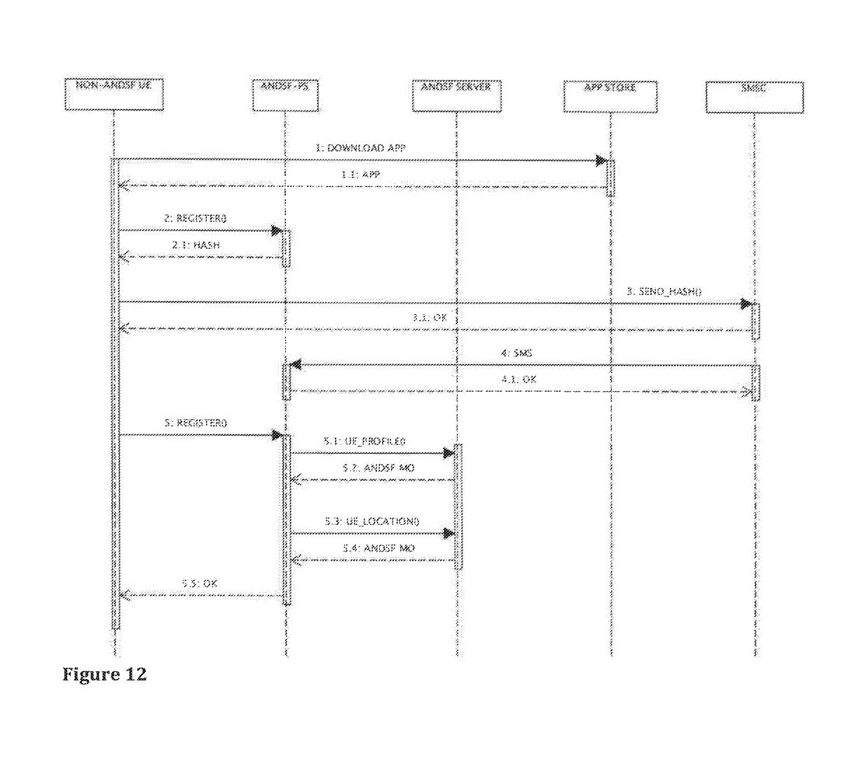

During the installation phase the application authenticates and registers the subscriber to the ANDSF-PS. Inserted SIM card's MCC+MNC information is utilized to resolve the respective operator's ANDSF-PS instance to communicate with. Uplink SMS is used to authenticate the user and resolve his/her MSISDN/IMSI. After successful registration the client SW sleeps on the background waiting for server triggers. Decided by a local policy, time-to-time the client wakes up and performs a device information update to the ANDSF-PS. No preconfigured WLAN network information or policy rules are deployed to the UE during the registration. Successful registration triggers ANDSF-PS to fetch the initial access policy from the ANDSF server to its local storage. See FIG. 12.

### 2.2.2 Time, Location and Prioritized WLAN Network Access

In case of HCMP device, ANDSF-PS's ANDSF policy check is triggered by device information updates. This information typically contains data related to existing device connection, location (cell ID, geo-log, BSSIDs), available WLAN networks, user context (stationary, moving) etc. The source of the information is from the client SW and/or the core network.

Upon getting a device information update message (uCLInfo), ANDSF-PS fetches the latest ANDSF policy (or uses the already existing local copy) and starts the offload/onload process in case there is a positive trigger. Offloading process consists of a creation of temporal credentials and sending those to the client SW which on the device side creates a new WLAN profile with the obtained information (SSID, authentication mode, credentials).

When the device accesses the WLAN network, ANDSF-PS gets a RADIUS request with the temporal credentials. If needed, ANDSF-PS can pass the access (and accounting) requests further on to the operator's master AAA—after converting the identity to MSISDN/IMSI.

The following numbered clauses describe some example embodiments of the invention.
Clause 1. A method for managing access to one or more wireless networks in a policy proxy server, the method comprising
   receiving, from a network policy server, a network access policy for a mobile communication device, the network access policy defining one or more rules for determining wireless networks that are currently recommended for said mobile communication device,
   executing, in response to receiving a trigger signal, said network access policy to select one or more recommended wireless networks for said mobile communication device, and
   enforcing said network access policy by providing, to a remote entity, an authorization indication regarding at least one of said one or more recommend wireless networks.
Clause 2. A method according to clause 1, wherein the network access policy for said mobile communication device is selected on basis of at least one of the following: indication of identity of the mobile communication device, indication of location of the mobile communication device.
Clause 3. A method according clause 1 or 2, wherein the network policy server is an ANDSF server
Clause 4. A method according to any of clauses 1 to 3, wherein said one or more rules are arranged to determine wireless networks that are currently recommended for said mobile communication device on basis of one or more of the following:
   location of the mobile communication device,
   time of the day,
   day of the week
   a predefined list of wireless networks,
   availability statuses of the wireless networks in said list,
   a priority order of the wireless networks in said list.
Clause 5. A method according to any of clauses 1 to 4, further comprising updating the network access policy for said mobile communication device in response to receiving an updated network access policy from the network policy server.
Clause 6. A method according to any of clauses 1 to 5, further comprising requesting, from the network policy server, an updated network access policy for said mobile communication device in response to one or more of the following:
   expiration of a validity period defined for the network access policy,
   a predefined time of the day and/or a predetermined day of the week,
   receiving an indication of the mobile communication device entering/exiting one of one or more predefined locations,
   receiving an indication of connectivity status of the mobile communication device with respect to a cellular wireless network changing to one of predetermined statuses,
   receiving an indication of connectivity status of the mobile communication device with respect to a wireless local area network changing to one of predetermined statuses.
Clause 7. A method according to any of clauses 1 to 6, further comprising providing one or more predetermined wireless network access profiles to said mobile communication device in response to one or more of the following,
   receiving a registration request from the mobile communication device,
   updating the network access policy.
Clause 8. A method according to any of clauses 1 to 7,
   wherein said trigger signal comprises an authorization request from an authorization server, said authorization request requesting access to a specific wireless network for said mobile communication device, and
   wherein enforcing the network access policy comprises providing, to the authorization server, an authorization indication that indicates that said mobile communication device is authorized to access said specific network in response to said specific wireless network being one of the wireless networks currently recommended for said mobile communication device.
Clause 9. A method according to any of clauses 1 to 7,
   wherein said trigger signal comprises an authorization request from an authorization server, said authorization request requesting access to a wireless network for said mobile communication device, and
   wherein enforcing the network access policy comprises providing, to the authorization server, an authorization indication that indicates that said mobile communication device is authorized to access said wireless networks currently recommended for said mobile communication device.
Clause 10. A method according to any of clauses 1 to 7, wherein said trigger signal comprises a status update signal from said mobile communication device, and.
   wherein enforcing the network access policy comprises providing an authorization indication that indicates that said mobile communication device is authorized to access said wireless networks currently recommended for said mobile communication device to one of the following entities:
      the mobile communication device,
      an authorization server,
      a policy enforcement entity.
Clause 11. A method according to clause 10, wherein said status update signal comprises at least one of the following: indication of identity of the mobile communication device, indication of location of the mobile communication device.
Clause 12. A method according to any of clauses 1 to 7, wherein said trigger signal comprises a trigger signal originating from one of an authorization server, a policy enforcement entity and a core network entity, and.
   wherein enforcing the network access policy comprises providing an authorization indication that indicates that said mobile communication device is authorized to access said wireless networks currently recommended for said mobile communication device to one of the following entities:
   the mobile communication device,
   an authorization server,
   a policy enforcement entity.
Clause 13. A computer program for managing access to one or more wireless networks in a policy proxy server, the computer program including one or more sequences of one or more instructions which, when executed by one or more processors, cause an apparatus to at least perform the method according to one of clauses 1 to 12.
Clause 14. A policy proxy server apparatus for managing access to one or more wireless networks, the policy proxy server comprising at least one processor and at least one memory including computer program code for one or more programs, the at least one memory and the computer program code configured to, with the at least one processor, cause the apparatus to perform at least the following
   receive, from a network policy server, a network access policy for a mobile communication device, the network access policy defining one or more rules for determining wireless networks that are currently recommended for said mobile communication device,
   execute, in response to receiving a trigger signal, said network access policy to select one or more recommended wireless networks for said mobile communication device, and
   enforce said network access policy by providing, to a remote entity, an authorization indication regarding at least one of said one or more recommend wireless networks.
Clause 15. An apparatus according to clause 14, wherein the network access policy for said mobile communication device is selected on basis of at least one of the following: indication of identity of the mobile communication device, indication of location of the mobile communication device.
Clause 16. An apparatus according clause 14 or 15, wherein the network access policy is received from an ANDSF server
Clause 17. An apparatus according to any of clauses 14 to 16, wherein said one or more rules are arranged to determine wireless networks that are currently recommended for said mobile communication device on basis of one or more of the following:
   location of the mobile communication device,
   time of the day,
   day of the week
   a predefined list of wireless networks,
   availability statuses of the wireless networks in said list,
   a priority order of the wireless networks in said list.
Clause 18. An apparatus according to any of clauses 14 to 17, further caused to update the network access policy for said mobile communication device in response to receiving an updated network access policy from the network policy server.
Clause 19. An apparatus method according to any of clauses 14 to 18, further caused to request, from the network policy server, an updated network access policy for said mobile communication device in response to one or more of the following:
   expiration of a validity period defined for the network access policy,
   a predefined time of the day and/or a predetermined day of the week,
   receiving an indication of the mobile communication device entering/exiting one of one or more predefined locations,
   receiving an indication of connectivity status of the mobile communication device with respect to a cellular wireless network changing to one of predetermined statuses,
   receiving an indication of connectivity status of the mobile communication device with respect to a wireless local area network changing to one of predetermined statuses.
Clause 20. An apparatus according to any of clauses 14 to 19, further caused to provide one or more predetermined wireless network access profiles to said mobile communication device in response to one or more of the following,
   receiving a registration request from the mobile communication device,
   updating the network access policy.
Clause 21. An apparatus according to any of clauses 14 to 20,
   wherein said trigger signal comprises an authorization request from an authorization server, said authorization request requesting access to a specific wireless network for said mobile communication device, and
   wherein enforcing the network access policy comprises providing, to the authorization server, an authorization indication that indicates that said mobile communication device is authorized to access said specific network in response to said specific wireless network being one of the wireless networks currently recommended for said mobile communication device.
Clause 22. An apparatus according to any of clauses 14 to 20,
   wherein said trigger signal comprises an authorization request from an authorization server, said authorization request requesting access to a wireless network for said mobile communication device, and
   wherein enforcing the network access policy comprises providing, to the authorization server, an authorization indication that indicates that said mobile communication device is authorized to access said wireless networks currently recommended for said mobile communication device.
Clause 23. An apparatus according to any of clauses 14 to 20, wherein said trigger signal comprises a status update signal from said mobile communication device, and.
   wherein enforcing the network access policy comprises providing an authorization indication that indicates that said mobile communication device is authorized to access said wireless networks currently recommended for said mobile communication device to one of the following entities:
      the mobile communication device,
      an authorization server,
      a policy enforcement entity.
Clause 24. An apparatus according to clause 23, wherein said status update signal comprises at least one of the following: indication of identity of the mobile communication device, indication of location of the mobile communication device.
Clause 25. An apparatus according to any of clauses 14 to 20, wherein said trigger signal comprises a trigger signal originating from one of an authorization server, a policy enforcement entity and a core network entity, and.
   wherein enforcing the network access policy comprises providing an authorization indication that indicates that said mobile communication device is authorized to access said wireless networks currently recommended for said mobile communication device to one of the following entities:
   the mobile communication device,
   an authorization server,
   a policy enforcement entity.
Clause 26. A system for managing access to one or more wireless networks, the system comprising
   a policy proxy server according to any of clauses 14 to 25, and
   a network policy server for storing, managing and providing network access policies, the network policy server configured to provide, in response to a request, said network access policy to the policy proxy server in accordance with the request.
Clause 27. A system according to clause 26, wherein the network policy server is configured to provide an updated network access policy to the policy proxy server in response in response to an update or change in the respective network access policy in the network policy server.
Clause 28. A system according to clause 26 or 27, further comprising an authorization server for controlling access to said one or more wireless networks, the authorization server configured to provide an authorization request to the policy proxy server in response to said mobile communication device attempting to access one of said wireless networks.
Clause 29. A system according to clause 28, wherein the authorization server is further configured to receive an authentication indication from the network policy server and to update its internal records with respect to wireless network(s) the mobile communication device is currently allowed and/or not allowed to access in accordance with the authorization indication.
Clause 30. A system according to any of clauses 26 to 29, further comprising a policy enforcement server for controlling access to said one or more wireless networks, the policy enforcement server configured to provide an authorization request to the policy proxy server in response to said mobile communication device attempting to access one of said wireless networks.
Clause 31. A system according to clause 30, wherein the policy enforcement server is further configured to receive an authentication indication from the network policy server and to update its internal rec-records with respect to wireless network(s) the mobile communication device is currently allowed and/or not allowed to access in accordance with the authorization indication.

The exemplifying embodiments of the invention presented in this text are not to be interpreted to pose limitations to the applicability of the appended claims. The verb “to comprise” and its derivatives are used in this text as an open limitation that does not exclude the existence of also unrecited features. The features described hereinbefore are mutually freely combinable unless explicitly stated otherwise.

### REFERENCES

[1] Access Network Discovery and Selection Function (ANDSF) Management Object (MO). 3^{rd} Generation Partnership Project; Technical Specification Group Core Network and Terminals. TS 24.312 V12.0.0.
[2] FreeRADIUS server. http://www.freeradius.org.
[3] 3GPP 24.302. 3rd Generation Partnership Project; Technical Specification Group Core Network and Terminals; Access to the 3GPP Evolved Packet Core (EPC) via non-3GPP access networks; Stage 3 (Release 12).
[4] Remote Authentication Dial In User Service (RADIUS) RFC 2865 (and many additional IETF RFCs extending the basic protocol)
[5] Diameter protocol IETF RFCs 6733, 4005, 4072
[6] 3GPP 23.203 3rd Generation Partnership Project; Technical Specification Group Services and System Aspects; Policy and charging control architecture (Release 9)

1. A method for managing access to one or more wireless networks in a policy proxy server, the method comprising
receiving, from a network policy server, a network access policy for a mobile communication device, the network access policy defining one or more rules for determining wireless networks that are currently recommended for said mobile communication device,
executing, in response to receiving a trigger signal, said network access policy to select one or more recommended wireless networks for said mobile communication device, wherein said trigger signal comprises an authorization request from an authorization server, said authorization request requesting access to a specific wireless network for said mobile communication device, and
enforcing said network access policy by providing, to a remote entity, in response to said specific wireless network being one of the wireless networks currently recommended for said mobile communication device, an authorization indication that indicates that said mobile communication device is authorized to access said specific network, wherein said remote entity comprises an authorization server.

2. A method according to claim 1, wherein the network access policy for said mobile communication device is selected on basis of at least one of the following: indication of identity of the mobile communication device, indication of location of the mobile communication device.

3. A method according claim 1, wherein the network policy server is an ANDSF server

4. A method according to claim 1, wherein said one or more rules are arranged to determine wireless networks that are currently recommended for said mobile communication device on basis of one or more of the following:
location of the mobile communication device,
time of the day,
day of the week
a predefined list of wireless networks,
availability statuses of the wireless networks in said list,
a priority order of the wireless networks in said list.

5. A method according to claim 1, further comprising updating the network access policy for said mobile communication device in response to receiving an updated network access policy from the network policy server.

6. A method according to claim 1, further comprising requesting, from the network policy server, an updated network access policy for said mobile communication device in response to one or more of the following:
expiration of a validity period defined for the network access policy,
a predefined time of the day and/or a predetermined day of the week,
receiving an indication of the mobile communication device entering/exiting one of one or more predefined locations,
receiving an indication of connectivity status of the mobile communication device with respect to a cellular wireless network changing to one of predetermined statuses,
receiving an indication of connectivity status of the mobile communication device with respect to a wireless local area network changing to one of predetermined statuses.

7. A method according to claim 1, further comprising providing one or more predetermined wireless network access profiles to said mobile communication device in response to one or more of the following,
receiving a registration request from the mobile communication device,
updating the network access policy.

8. A computer program for managing access to one or more wireless networks in a policy proxy server, the computer program including one or more sequences of one or more instructions which, when executed by one or more processors, cause an apparatus to at least perform the method according to claim 1.

9. A policy proxy server apparatus for managing access to one or more wireless networks, the policy proxy server apparatus comprising at least one processor and at least one memory including computer program code for one or more programs, the at least one memory and the computer program code configured to, with the at least one processor, cause the apparatus to perform at least the following
receive, from a network policy server, a network access policy for a mobile communication device, the network access policy defining one or more rules for determining wireless networks that are currently recommended for said mobile communication device,
execute, in response to receiving a trigger signal, said network access policy to select one or more recommended wireless networks for said mobile communication device, wherein said trigger signal comprises an authorization request from an authorization server, said authorization request requesting access to a specific wireless network for said mobile communication device, and
enforce said network access policy by providing, to a remote entity, in response to said specific wireless network being one of the wireless networks currently recommended for said mobile communication device, an authorization indication that indicates that said mobile communication device is authorized to access said specific network, wherein said remote entity comprises an authorization server.

10. An apparatus according to claim 9, wherein the network access policy for said mobile communication device is selected on basis of at least one of the following: indication of identity of the mobile communication device, indication of location of the mobile communication device.

11. An apparatus according claim 9, wherein the network access policy is received from an ANDSF server

12. An apparatus according to claim 9, wherein said one or more rules are arranged to determine wireless networks that are currently recommended for said mobile communication device on basis of one or more of the following:
location of the mobile communication device,
time of the day,
day of the week
a predefined list of wireless networks,
availability statuses of the wireless networks in said list,
a priority order of the wireless networks in said list.

13. An apparatus according to claim 9, further caused to update the network access policy for said mobile communication device in response to receiving an updated network access policy from the network policy server.

14. An apparatus method according to claim 9, further caused to request, from the network policy server, an updated network access policy for said mobile communication device in response to one or more of the following:
expiration of a validity period defined for the network access policy,
a predefined time of the day and/or a predetermined day of the week,
receiving an indication of the mobile communication device entering/exiting one of one or more predefined locations,
receiving an indication of connectivity status of the mobile communication device with respect to a cellular wireless network changing to one of predetermined statuses,
receiving an indication of connectivity status of the mobile communication device with respect to a wireless local area network changing to one of predetermined statuses.

15. An apparatus according to claim 9, further caused to provide one or more predetermined wireless network access profiles to said mobile communication device in response to one or more of the following,
receiving a registration request from the mobile communication device,
updating the network access policy.

16. A system for managing access to one or more wireless networks, the system comprising
a policy proxy server according to claim 9, and
a network policy server for storing, managing and providing network access policies, the network policy server configured to provide, in response to a request, said network access policy to the policy proxy server in accordance with the request.

17. A system according to claim 16, wherein the network policy server is configured to provide an updated network access policy to the policy proxy server in response in response to an update or change in the respective network access policy in the network policy server.

18. A system according to claim 16, further comprising an authorization server for controlling access to said one or more wireless networks, the authorization server configured to provide an authorization request to the policy proxy server in response to said mobile communication device attempting to access one of said wireless networks.

19. A system according to claim 18, wherein the authorization server is further configured to receive an authentication indication from the network policy server and to update its internal records with respect to wireless network(s) the mobile communication device is currently allowed and/or not allowed to access in accordance with the authorization indication.

20. A system according to claim 16, further comprising a policy enforcement server for controlling access to said one or more wireless networks, the policy enforcement server configured to provide an authorization request to the policy proxy server in response to said mobile communication device attempting to access one of said wireless networks.

21. A system according to claim 20, wherein the policy enforcement server is further configured to receive an authentication indication from the network policy server and to update its internal records with respect to wireless network(s) the mobile communication device is currently allowed and/or not allowed to access in accordance with the authorization indication.
